(19) United States
(12) Patent Application Publication
(10) Pub. No.: US 2025/0077395 A1
(43) Pub. Date: Mar. 6, 2025

(54) MEASUREMENT APPLICATION DEVICE SCRIPT ANALYZER, MEASUREMENT APPLICATION DEVICE, AND COMPUTER-IMPLEMENTED METHOD

(71) Applicant: Rohde & Schwarz GmbH & Co. KG, München (DE)

(72) Inventors: Konstantin PAULUS, München (DE); Sebastian ROEGLINGER, Pfaffenhofen (DE)

(21) Appl. No.: 18/459,642

(22) Filed: Sep. 1, 2023

(51) Int. Cl. G06F 11/36

(52) U.S. Cl. CPC G06F 11/3684; G06F 11/3688

(57) ABSTRACT

The present disclosure provides a measurement application device script analyzer comprising a script input interface configured to receive a control script for a measurement application device, an instruction analyzer coupled to the script input interface, and configured to analyze instructions of the control script for compliance with a predetermined rule set, and to provide a respective analysis result, and an output interface coupled to the instruction analyzer, and configured to output the analysis result. Further, the present disclosure provides a respective measurement application device, and a respective computer-implemented method.

### TECHNICAL FIELD

The disclosure relates to a measurement application device script analyzer. Further, the present disclosure provides a respective measurement application device, and a respective computer-implemented method.

### BACKGROUND

Although applicable to any type of measurement application device control script, the present disclosure will mainly be described in conjunction with Standard Commands for Programmable Instruments (SCPI) or Python scripts in measurement applications.

Modern measurement application devices may comprise the capability to execute user-provided scripts. Such scripts may, however, comprise potentially dangerous operations. A user may unintentionally e.g., in case of an unexperienced user, or intentionally e.g., in case of a hacker, use such operations in a control script for a measurement application device.

Accordingly, there is a need for improving measurement application scripting security.

### SUMMARY

The above stated problem is solved by the features of the independent claims. It is understood, that independent claims of a claim category may be formed in analogy to the dependent claims of another claim category.

Accordingly, it is provided:

A measurement application device script analyzer comprising a script input interface configured to receive a control script for a measurement application device, an instruction analyzer coupled to the script input interface, and configured to analyze instructions of the received control script for compliance with a predetermined rule set, and to provide a respective analysis result, and an output interface coupled to the instruction analyzer, and configured to output the analysis result.

Further, it is provided:

A measurement application device comprising a script analyzer, and a measurement application device controller coupled to the script analyzer, wherein the measurement application device controller is configured to execute a control script after receiving a positive analysis result from the script analyzer, wherein the script analyzer comprises a script input interface configured to receive a control script at least for the measurement application device, an instruction analyzer coupled to the script input interface, and configured to analyze instructions of the received control script for compliance with a predetermined rule set, and to provide a respective analysis result, and an output interface coupled to the instruction analyzer, and configured to output the analysis result.

Further, there is provided:

A computer-implemented method comprising receiving a control script for at least one measurement application device, analyzing instructions of the received control script for compliance with a predetermined rule set, and outputting a respective analysis result.

The present disclosure is based on the finding that modern measurement application devices allow executing externally generated scripts, and on the finding that such scripts may unintentionally or intentionally comprise potentially harmful commands or instructions.

For example, a hacker could try to infiltrate a company network via a malicious control script for a measurement application device, by executing scripts that access the network interface of a measurement application device, and that try to infect other network-attached devices with viruses or backdoors.

In other examples, inexperienced users could unintentionally include commands or instructions in a control script that set electrical parameters that might damage the measurement application device or other devices coupled to the measurement application device, like a device under test, DUT, or other measurement application devices.

Other examples of code that may potentially comprise harmful commands or instructions, may be code generated automatically via an artificial intelligence algorithm, like a large language model.

Therefore, the present disclosure provides the measurement application device script analyzer, a respective measurement application device, and a respective method.

For the purpose of the present disclosure, the terms “command” or “instruction” may be interchangeably used, and where the term command is used, the term instruction may also be used, and vice versa.

The measurement application device script analyzer comprises a script input interface for receiving a control script for the measurement application device.

The measurement application device script analyzer may in embodiments be implemented as a stand-alone device. Such a stand-alone device may implement the measurement application device script analyzer as a network-attached device or service that may be accessed by other devices via a network. A respective server may execute respective instructions that when executed by a processor of the server cause the processor to perform the functions of the measurement application device script analyzer, or the steps of the respective method.

Such a server may be a dedicated server that may be implemented as a single hardware device. The server may also be implemented as a distributed system comprising a plurality of servers, optionally with a load balancer, that distributes the load over the servers. The server may also be provided as a so-called cloud or cloud-server system that implements the server via virtualization methods independently of the underlying hardware.

In other embodiments, the measurement application device script analyzer may be implemented in or may be comprised in a measurement application device. Such a measurement application device may implement the measurement application device script analyzer as additional function, program or application that may be executed by a processor of the measurement application device. In such embodiments, the measurement application device controller may use the measurement application device script analyzer to statically analyze scripts that are provided to the measurement application device but are not currently executed, and to dynamically analyze scripts or single instructions of a script as they are executed in the measurement application device, or as they are received for execution.

Generally, the measurement application device script analyzer may comprise or may be provided in or as part of at least one of a dedicated processing element e.g., a processing unit, a microcontroller, a field programmable gate array, FPGA, a complex programmable logic device, CPLD, an application specific integrated circuit, ASIC, or the like. A respective program or configuration may be provided to implement the required functionality. The measurement application device script analyzer may at least in part also be provided as a computer program product comprising computer readable instructions that may be executed by a processing element. In a further embodiment, the measurement application device script analyzer may be provided as addition or additional function or method to the firmware or operating system of a processing element that is already present in the respective application as respective computer readable instructions. Such computer readable instructions may be stored in a memory that is coupled to or integrated into the processing element. The processing element may load the computer readable instructions from the memory and execute them. The same applies to any other element, unit or function disclosed herein as part of the measurement application device script analyzer, and the respective method, like the instruction analyzer, and the comparator in the instruction analyzer, or the measurement application device controller.

In addition, it is understood, that any required supporting or additional hardware may be provided like e.g., a power supply circuitry and clock generation circuitry.

When implemented as a stand-alone device, the input interface may comprise a data interface or a communication interface that may receive the control script from another device, as already indicated above. With a hardware-based script input interface, the script input interface may comprise any kind of wired and wireless communication interfaces, like for example a network communication interface, especially an Ethernet, wireless LAN or WIFI interface, a USB interface, a Bluetooth interface, an NFC interface, a visible or non-visible light-based interface, especially an infrared interface.

When implemented in a measurement application device or any other device, the script input interface may comprise a respective interface of the respective device, or the script input interface may be a software-based interface that may include, but is not limited to, an API, a callback function, or a shared memory interface. A combination of a hardware-based script input interface, and a software-based interface is possible.

The received control script is then provided to the instruction analyzer. The instruction analyzer will then analyze the control script. Analyzing in this context refers to the instruction analyzer verifying if the control script complies with a predetermined rule set. The instruction analyzer provides a respective analysis result, and provides the analysis result to the output interface for outputting the analysis result.

The output interface may be a dedicated interface. In other embodiments, the output interface may be a combined interface with the script input interface. A combined interface may be provided e.g., with a measurement application device script analyzer that is provided as dedicated device by providing a single network interface as script input interface, and output interface.

When implemented in a measurement application device, the measurement application device script analyzer may be provided as function or application in the measurement application device.

Generally, a measurement application device according to the present disclosure may comprise any device that may be used in a measurement application to acquire an input signal or to generate an output signal, or to perform additional or supporting functions in a measurement application. A measurement application device may also comprise or be implemented as application or applications, also called measurement application or measurement applications, that may be executed on a computer device and that may communicate with other measurement application devices in order to perform a measurement task. A measurement application, also called measurement setup, may e.g., comprise at least one or multiple different measurement application devices for performing electric, magnetic, or electromagnetic measurements, especially on single devices under test. Such electric, magnetic, or electromagnetic measurements may be performed in a measurement laboratory or in a production facility in the respective production line. A measurement application or measurement setup may serve to qualify the single devices under test i.e., to determine the proper electrical operation of the respective devices under test.

Measurement application devices to this end may comprise at least one signal acquisition section for acquiring electric, magnetic, or electromagnetic signals to be measured from a device under test, or at least one signal generation section for generating electric, magnetic, or electromagnetic signals that may be provided to the device under test. Such a signal acquisition section may comprise, but is not limited to, a front-end for acquiring, filtering, and attenuating or amplifying electrical signals. The signal generation section may comprise, but is not limited to, respective signal generators, amplifiers, and filters.

Further, when acquiring signals, measurement application devices may comprise a signal processing section that may process the acquired signals. Processing may comprise converting the acquired signals from analog to digital signals, and any other type of digital signal processing, for example, converting signals from the time-domain into the frequency-domain.

The measurement application devices may also comprise a user interface to display the acquired signals to a user and allow a user to control the measurement application devices. Of course, a housing may be provided that comprises the elements of the measurement application device. It is understood, that further elements, like power supply circuitry, and communication interfaces may be provided.

A measurement application device may be a stand-alone device that may be operated without any further element in a measurement application to perform tests on a device under test. Of course, communication capabilities may also be provided for the measurement application device to interact with other measurement application devices.

A measurement application device may comprise, for example, a signal acquisition device e.g., an oscilloscope, especially a digital oscilloscope, a spectrum analyzer, or a vector network analyzer. Such a measurement application device may also comprise a signal generation device e.g., a signal generator, especially an arbitrary signal generator, also called arbitrary waveform generator, or a vector signal generator. Further possible measurement application devices comprise devices like calibration standards, or measurement probe tips.

Of course, at least some of the possible functions, like signal acquisition and signal generation, may be combined in a single measurement application device.

In embodiments, the measurement application device may comprise pure data acquisition devices that are capable of acquiring an input signal and of providing the acquired input signal as digital input signal to a respective data storage or application server. Such pure data acquisition devices not necessarily comprise a user interface or display. Instead, such pure data acquisition devices may be controlled remotely e.g., via a respective data interface, like a network interface or a USB interface. The same applies to pure signal generation devices that may generate an output signal without comprising any user interface or configuration input elements. Instead, such signal generation devices may be operated remotely via a data connection.

In other embodiments, as indicated above, the script input interface, and the output interface may comprise a data or communication interface, wherein the control script may be received via the data interface in a digital form. In such an embodiment, the measurement application device may be provided e.g., as a remote-control, or measurement data analysis, or general measurement application support application for remotely controlling or operating a measurement application with one or more measurement application devices. Such a remote-control, or measurement data analysis, or general measurement application support application may e.g., be a website that may be loaded from a server to a user device, like a computer, smartphone, or tablet PC. The website may comprise interactive elements, that may e.g., be provided using JavaScript programs, that allow the website to perform the functions disclosed herein for the measurement application device script analyzer. In other embodiments, the remote-control, or measurement data analysis, or general measurement application support application may comprise an API that is accessible via a network, like a REST-API.

In other embodiments, the remote-control, or measurement data analysis, or general measurement application support application may be provided as native application that may be executed by the operating system of a respective user device.

The present disclosure, also discloses a computer program product that comprises instructions that when executed by a processor cause the processor to perform the functions of a method according to any one of the embodiments of the method of the present disclosure.

Especially, the computer program product according to the present disclosure may in any embodiment disclosed herein, comprise instructions for implementing the method as a purely computer implemented method that is executed by a processor. Such a method may comprise steps of acquiring data or user input, or of outputting data or providing information to a user. It is understood, that in the case of a purely computer implemented method the method may comprise instructions that cause the processor to access peripherals of the computer that carries the processor that executes the instructions. If no other information is provided herein, the respective peripherals are those peripherals of the computer that perform the same function as the respective elements of the measurement application device script analyzer, or the measurement application device described as performing the same function.

Other embodiments for providing the measurement application device script analyzer may comprise the implementation of the measurement application device script analyzer running as an application on a user computer. Such a computer may receive the control script via a data carrier, like a USB stick, or via a network connection.

Another possible implementation comprises a browser plugin that may serve to analyze control scripts provided by an AI, e.g., a large language model, via the respective web interface.

With the measurement application device script analyzer, and the respective method, any control script that is intended to control a measurement application device may be analyzed for compliance with the predetermined rule set.

A use case the disclosure covers, is that a user enters a measurement he wants to run into an AI Tool via natural language (voice or text). The AI tool then generates the automation script. Thereafter the measurement application device script analyzer makes sure that the output can be safely executed on the device without the need for human validation. A further use case allows different personas to profit from the measurement application device script analyzer, even if the control script is generated without AI tools i.e., the control scripts are written by the users. For example, for an RF expert checks for instructions or commands that could damage a device are not as important, as checks for instructions that may refer to security vulnerabilities. In contrast, for a software expert, checks for instructions or commands that could damage a device are more important than checks for instructions that may refer to security vulnerabilities. For very inexperienced users, all checks may be highly relevant.

The rule set may, therefore, be adapted according to the users' skills.

As will be explained in more detail below, it is, therefore, possible to prevent possibly harmful, or dangerous scripts from being executed in a measurement application device with the measurement application device script analyzer, or the respective method.

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to the measurement application device script analyzer can be combined in all variations with each other and the disclosure of the description is not limited to the claim dependencies as specified in the claim set. Further, the features of the other independent claims may be combined with any of the features of the dependent claims relating to the measurement application device script analyzer in all variations, wherein respective method steps perform the function of the respective apparatus elements of the measurement application device script analyzer, and the measurement application device.

In an embodiment, which can be combined with all other embodiments of the measurement application device script analyzer mentioned above or below, the control script may be provided in a scripting language that is interpretable by the measurement application device.

As indicated above, modern measurement application devices may comprise the capability of executing scripts in specific scripting languages.

Usually, one feature of such scripting languages is that the control scripts provided in such a scripting language are not compiled, and may, consequently, be easily analyzed.

In another embodiment, which can be combined with all other embodiments of the measurement application device script analyzer mentioned above or below, the control script may be provided as at least one of a SCPI script, or a Python script.

The expression SCPI refers to the Standard Commands for Programmable Instruments scripting language for controlling measurement application devices. Measurement application devices usually support the SCPI scripting language, since it was specifically designed for controlling measurement application device.

Another, potentially more powerful, and therefore also more harmful, scripting language that is supported by many measurement application devices is Python.

The instruction analyzer being configured to analyze SCPI or Python scripts or instructions may operate directly on the sources of the respective control scripts. That simplifies the analysis of the control script. Of course, any other scripting language may also be supported.

In other embodiments, the control script may be provided in a compiled form as supported by the respective measurement application device. Such a control script may be based on any other programming language that requires compiling, like C, or C++.

In such cases, the instruction analyzer may comprise a decompiler or disassembler for transforming the compiled control script into a form that may be analyzed more easily.

In a further embodiment, which can be combined with all other embodiments of the measurement application device script analyzer mentioned above or below, the predetermined rule set may comprise rules that define at least one of instructions or commands that are not allowed, instructions or commands that may cause unwanted consequences, and instructions or commands that comprise parameters with the potential to damage the measurement application device, or other devices coupled to the measurement application device.

The rule set may comprise different rules that may define different criteria for analyzing the control script.

The rules may refer e.g., to instructions that are not allowed to be executed. Such rules may each define a specific command or instruction, or a list of commands or instructions. If the instruction analyzer encounters such a command or instruction in the received control script, the instruction analyzer may output a negative analysis result.

Examples of instructions that may not be allowed may comprise, but are not limited to, commands that access a file system of the respective measurement application device, commands that execute other software that may potentially be malware, and commands that access the internet or other network resources.

In further embodiments, such rules may each comprise one or more commands with respective parameters. The instruction analyzer may in such cases output the negative analysis result, if the respective control script comprises such a command together with a parameter that is not allowed according to the respective rule. For example, many SCPI commands may comprise additional parameters e.g., for setting an output voltage, or an output current, or an output frequency, or other output or input parameters of a measurement application device. In such cases, the rules may be provided with allowed, or not-allowed values or value ranges for the respective parameters. The instruction analyzer may then provide a negative analysis result if the parameters for the commands in the control script are outside of the allowed range.

Instructions that may cause unwanted consequences may comprise, but are not limited to, instructions that, for example, refer to deleting an acquired license from a measurement application device, instructions that purchase a license, or an application for a measurement application device, instructions that cause follow-up costs when executing the control script, and instructions that try to access other devices within the same network.

Instructions that comprise parameters with the potential to damage the measurement application device, or other devices coupled to the measurement application device may refer to instructions that are generally considered to be allowable, but under certain circumstances may damage the measurement application device, or other devices coupled to the device under test.

Such instructions may comprise instructions that set specific parameters of the respective measurement application device based on a parameter included with the respective instruction. Usually, such instructions may refer to setting an output power, or a voltage level, especially a negative voltage level, of a port of a measurement application device, or that modify an input resistance of a port of a measurement application device.

It is understood, that specific instructions of the same type may be categorized into different categories or may be assigned rules in different categories, depending on the danger a respective instruction poses to a measurement application.

With the measurement application device script analyzer, or the respective method it is, therefore, possible to ensure that the control script only contains valid instructions, that the control script damages neither the hardware nor the software, and that the control script does not exploit any security vulnerabilities.

In embodiments, the rule sets may be provided by a manufacturer of the measurement application device script analyzer, or by a manufacturer of the measurement application device, or both. The instruction analyzer may comprise a rule memory and may receive rules from different sources, like different users, and different vendors of measurement application devices. The instruction analyzer may also be configured to retrieve the rule set or single rules regarding specific measurement application devices from a remote source, like a server or a network attached storage.

In embodiments, the rules of the rule set may comprise positive rules that indicate criteria that the control script needs to fulfill in order to pass the code analysis. In other embodiments, the rules of the rule set may comprise negative rules that indicate criteria that the control script must not fulfill in order to pass the code analysis. A mix of positive and negative rules in the rule set is possible.

In another embodiment, which can be combined with all other embodiments of the measurement application device script analyzer mentioned above or below, the instruction analyzer may comprise a sandbox environment, and for analyzing the control script, may execute the control script in the sandbox environment, and monitor the behavior of the sandbox environment.

The above-presented rule set and details of the rules allow analyzing the control script prior to executing the control script. However, some unwanted consequences of the execution of the control script may only become visible when the control script is executed e.g., due to cross-interference that some commands may have with each other. For example, an access to the file system no necessarily needs to have negative or dangerous impact. However, depending on the content written to the file system, the impact may become negative or dangerous.

In cases, a malicious user may even try to obfuscate malicious code. Such code may eventually not be detected by rule-based analysis with rules that refer to single commands in the script.

The instruction analyzer may, therefore, comprise a sandbox environment. The term “sandbox environment” refers to a simulated environment that allows simulating a measurement application device, and executing the control script with the simulated measurement application device. The behavior of the simulated measurement application device may then be monitored for compliance with the rule set.

The rules in the rule set may in such an embodiment refer to the conditions within the simulated measurement application device.

The instruction analyzer may e.g., monitor the sandbox environment for the purchase of applications or licenses for using apps with pay-per-use licenses. Further, all external effects may be analyzed and checked against respective rules. The instruction analyzer may monitor e.g., for a manipulation of the file system, the replacement of an FPGA image with malware, for network access, especially, the download of malware, and the execution of a DDOS attack. Further, the instruction analyzer may monitor hardware limitations, for example insufficient memory, interface limitations, and the lack of a specific application for performing specific measurement tasks. The instruction analyzer may also monitor for hardware component availability, like a lack of measurement ports in the simulated measurement application device.

With a sandbox environment, the analysis of the control script may, therefore, be completed to also monitor for circumstances that only occur in the measurement application device, and may not easily be detected by analyzing the instructions of the control script.

In a further embodiment, which can be combined with all other embodiments of the measurement application device script analyzer mentioned above or below, the instruction analyzer may be configured to, if the analysis result is negative, at least one of reject the control script, ask for a user confirmation to accept the control script, and modify the script to comply with the predetermined rule set.

Depending on the result of the analysis performed by the instruction analyzer, different consequences may follow.

A possible consequence of the control script failing the code analysis by the instruction analyzer may comprise the total rejection of the control script.

Another consequence may comprise asking the user for a confirmation to accept the control script and provide a positive analysis result. With such a consequence, a respective user interface may be provided for providing a respective query to the user. With such a query, the user may also be informed about the rule check that was not passed by the control script.

Further, the instruction analyzer may also be configured to modify the control script such that it complies with the respective rule or rules. For a modification of the script, the respective rule or rules may provide modification or transformation instructions. A transformation may exemplarily comprise, but is not limited to, reducing output power value parameters to a maximum limit, setting voltage levels to a value within an allowed range, and setting the input resistance of a port of a device to an allowed value.

In embodiments, the consequences may be defined in the rule set for all rules, or for single rules. For example, it may be defined, that with a single rule not being matched by the control script, the control script is rejected, or the user is asked for confirmation. In other embodiments, it may be defined for every rule of the rule set, how the instruction analyzer should react if the respective rule is not matched by the control script. A combination of both is possible. For example, for one rule it may be defined that if the check for this rule fails, the whole script is rejected. At the same time, for another rule it may be defined that if the check for this rule fails, the user may be asked for a confirmation for accepting the control script.

The measurement application device script analyzer may output the consequence e.g., rejection of the control script, asking for a user confirmation to accept the control script, or modifying the script to comply with the predetermined rule set, via the output interface.

When integrated into a measurement application device, the measurement application device may display the result of the analysis on a display together with the returned consequence. Therefore, a user may be informed via e.g., the display of the measurement application device, that the control script is rejected, or the user may be asked via the display if he wants to accept the control script, or the user may be informed on the display about modifications performed in the control script.

In embodiments, in which the measurement application device script analyzer is a stand-alone device, like a server that serves a website that is displayed to a user via a browser on his computer, the user may be informed via a respective element on that website about the analysis result, and the consequences. Especially, in networking environments that comprise multiple measurement application devices that are communicatively coupled to each other, the measurement application device script analyzer may, after completing the analysis, output the control script to the respective measurement application devices, if the control script passes the analysis, or if the user accepts the control script.

All the rules of the rule set may be applied without specific knowledge about a measurement application, especially about the measurement application devices used in the measurement application. In such cases, where applicable, threshold values may be defined, and the analysis of the control script may be performed based on the threshold values. Rules that do not require providing threshold values, like rules that indicate that a specific command or instruction must not be used, may of course also be applied.

If no further details about the measurement application are provided, a user may be informed that the analysis of the control script returned a negative result. In addition, the user may also be informed about every rule that was not passed by the control script. The user may in embodiments be allowed to decide, if in his specific situation, he still wants to execute the control script. In other embodiments, the consequences determined by the instruction analyzer may automatically be applied without the chance for the user to execute the original control script. Of course, different users may be provided with different levels of user privileges or access rights.

In another embodiment, which can be combined with all other embodiments of the measurement application device script analyzer mentioned above or below, the script input interface may further be configured to receive a measurement application description with the control script. The instruction analyzer may further be configured to analyze the received control script based on the measurement application description.

Instead of performing the analysis without knowledge of the measurement application, as described above, it is also possible to perform the analysis of the control script with specific knowledge about the details of the measurement application the control script is intended to be used in.

This allows determining parameters, or limits, or other details specifically for the measurement application devices that are present in the respective measurement application.

The measurement application description may comprise, but is not limited to, a wiring model, a description of a device under test, and of all measurement application devices used in the measurement application. This will allow determining, if a control script damages the device under test, or any one of the measurement application devices.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a block diagram of an embodiment of a measurement application device script analyzer according to the present disclosure;

FIG. 2 shows a block diagram of another embodiment of a measurement application device script analyzer according to the present disclosure;

FIG. 3 shows a block diagram of another embodiment of a measurement application device script analyzer according to the present disclosure;

FIG. 4 shows a block diagram of another embodiment of a measurement application device script analyzer according to the present disclosure;

FIG. 5 shows a block diagram of another embodiment of a measurement application device script analyzer according to the present disclosure;

FIG. 6 shows a block diagram of a measurement application with an embodiment of a measurement application device script analyzer according to the present disclosure;

FIG. 7 shows a flow diagram of an embodiment of a method according to the present disclosure;

FIG. 8 shows a block diagram of an oscilloscope that may be used with or as an embodiment of a measurement application device script analyzer according to the present disclosure; and

FIG. 9 shows a block diagram of another oscilloscope that may be used with or as an embodiment of a measurement application device script analyzer according to the present disclosure.

In the figures like reference signs denote like elements unless stated otherwise.

### DETAILED DESCRIPTION OF THE DRAWINGS

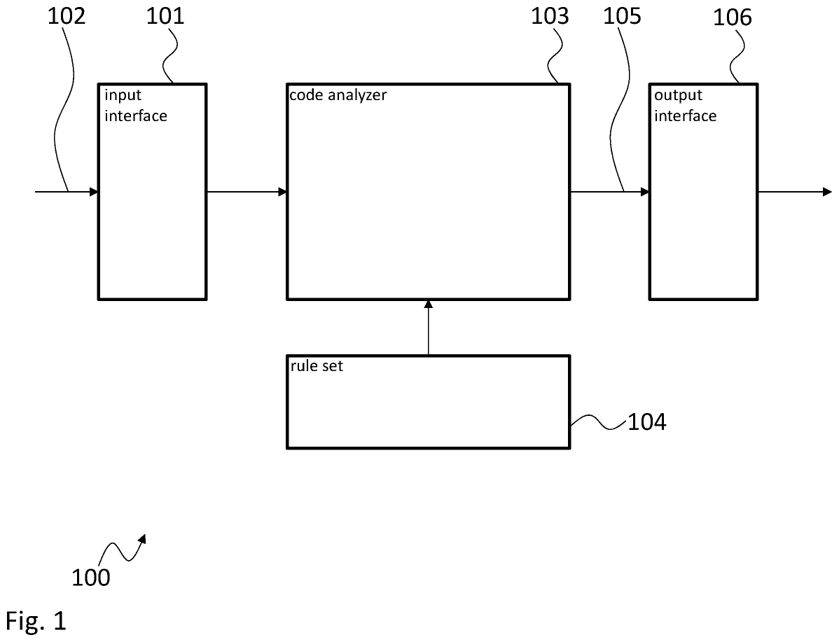

FIG. 1 shows a block diagram of a measurement application device script analyzer 100. The measurement application device script analyzer 100 comprises a script input interface 101 that is coupled to an instruction analyzer 103. The instruction analyzer 103 is coupled to an output interface 106.

When operating the measurement application device script analyzer 100, the script input interface 101 receives a control script 102, and provides the received control script 102 to the instruction analyzer 103.

The instruction analyzer 103 analyzes the instructions of the received control script 102 for compliance with a predetermined rule set 104, and provides a respective analysis result 105. The analysis result 105 is output via the output interface 106.

The control script 102 may be provided in any form, especially as interpretable script, or as compiled script or program. Any possible scripting language may be used. The control script 102 may exemplarily be provided as, but is not limited to, a SCPI script, a Python script, a JavaScript-based script, or a compiled C program, a compiled C++ program, or a Java program.

The control script 102 usually comprises at least one instruction or command for controlling the respective measurement application device. As indicated above, such an instruction or command may be potentially harmful to the measurement application device, or a device under test, or any other device coupled to the measurement application device.

Therefore, the instruction analyzer 103 may be provided with a rule set 104 that provides the instruction analyzer 103 with rules to assess whether the control script 102 is acceptable or not. To this end, the rule set 104 may comprise rules regarding instructions that are not allowed, instructions that may cause unwanted consequences, and instructions that comprise parameters with the potential to damage the measurement application device, or other devices coupled to the measurement application device, as already explained above.

If the instruction analyzer 103 detects that any of the rules is violated by the control script 102, a negative analysis result 105 may be provided by the instruction analyzer 103. If no one of the rules in the rule set 104 is violated, the instruction analyzer 103 may output a positive analysis result 105.

Instead of simply accepting or rejecting the control script 102 with a positive or negative analysis result 105, the instruction analyzer 103 may have further options to rejecting a control script 102 that does not fulfil all rules in the rule set 104. Such other options may comprise, but are not limited to, asking for a user confirmation to accept the control script, and modifying the script to comply with the predetermined rule set. Which of the options should be applied in case that not all rules of the rule set 104 are met, may be determined in the rule set 104.

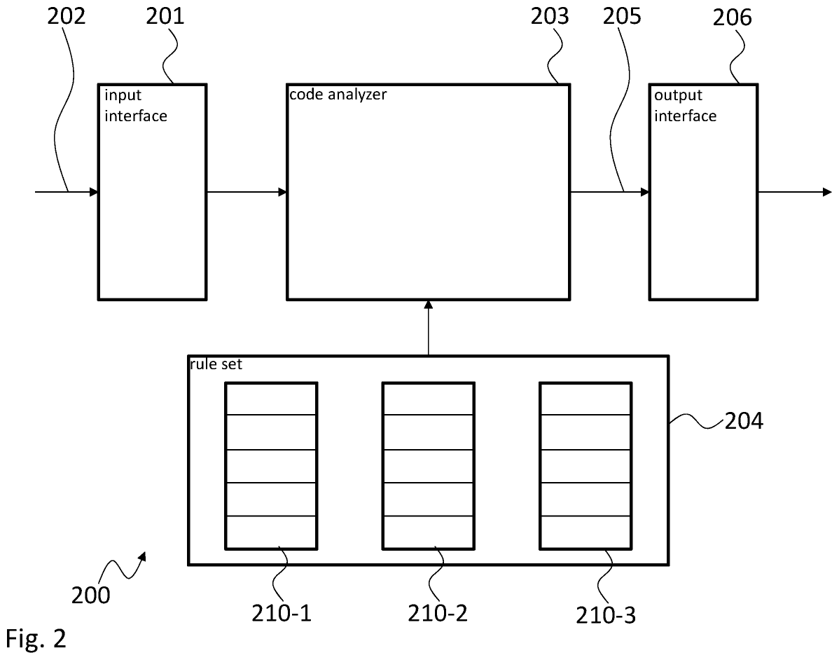

FIG. 2 shows a block diagram of a measurement application device script analyzer 200. The measurement application device script analyzer 200 is based on the measurement application device script analyzer 100. Therefore, the measurement application device script analyzer 200 comprises a script input interface 201 that is coupled to an instruction analyzer 203. The instruction analyzer 203 is coupled to an output interface 206. The explanations provided for any of the other embodiments of the measurement application device script analyzer herein apply mutatis mutandis to the measurement application device script analyzer 200.

The rule set 204 of the measurement application device script analyzer 200 comprises three groups of rules 210-1, 210-2, 210-3. Each one of the groups of rules 210-1, 210-2, 210-3 may comprise specific rules regarding different types of instructions. One of the groups of rules 210-1, 210-2, 210-3 may comprise instructions that are not allowed at all. Another one of the groups of rules 210-1, 210-2, 210-3 may comprise instructions that may cause unwanted consequences e.g., in a respective measurement application device. Another one of the groups of rules 210-1, 210-2, 210-3 may comprise instructions that comprise parameters with the potential to damage the measurement application device, or other devices coupled to the measurement application device.

In an embodiment, each one of the groups of rules 210-1, 210-2, 210-3 may include a specific consequence. For example, for instructions that are not allowed at all, the consequence may be to reject the control script 202. For instructions that may cause unwanted consequences, a user may be asked if he really wants to execute the control script 202. For instructions that comprise parameters with the potential to damage the measurement application device, or other devices coupled to the measurement application device, the script may be rewritten or amended not to damage the measurement application device, or other devices coupled to the measurement application device.

On other embodiments, instead of providing groups of rules 210-1, 210-2, 210-3, each rule may define an individual consequence.

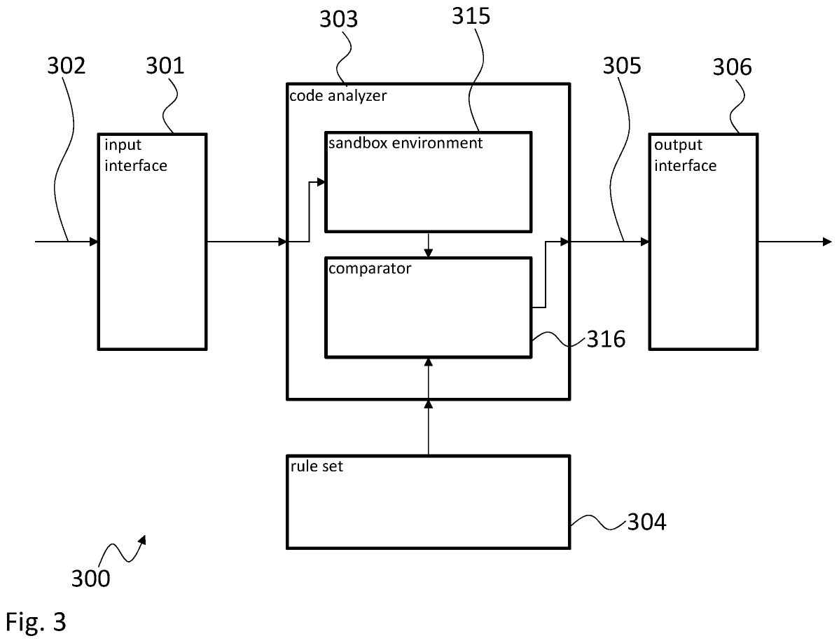

FIG. 3 shows a block diagram of a measurement application device script analyzer 300. The measurement application device script analyzer 300 is based on the measurement application device script analyzer 100. Therefore, the measurement application device script analyzer 300 comprises a script input interface 301 that is coupled to an instruction analyzer 303. The instruction analyzer 303 is coupled to an output interface 306. The explanations provided for any of the other embodiments of the measurement application device script analyzer herein apply mutatis mutandis to the measurement application device script analyzer 300.

In the measurement application device script analyzer 300, the instruction analyzer 303 comprises a sandbox environment 315 that receives the control script 302, and a comparator 316 that is coupled to the sandbox environment 315.

The sandbox environment 315 may be a simulated environment that provides a simulated measurement application device for executing the control script 302 in this simulated measurement application device. The comparator 316 may load the rule set 304 and verify if all rules of the rule set 304 are fulfilled by the control script 302 by monitoring the behavior of the simulated measurement application device in the sandbox environment 315. If all rules are fulfilled by the control script 302, a positive analysis result 305 may be output by the comparator 316 via the output interface 306.

In embodiments, the direct analysis of the control script 302 via a respective rule set 304, and the analysis of the control script 302 via a sandbox environment 315 may both be performed in combination. In such an embodiment, specific rules of the rule set may be provided for the direct analysis, and the analysis by simulation.

The rules for the analysis by simulation may e.g., comprise rules that limit consumption of specific resources in the sandbox environment 315 by the control script 302, such as memory consumption, hard disk memory consumption, and processing resource consumption. These rules may especially refer to variables or resources that may not directly be derived from the instructions of the control script 302, but that only become visible when executing the control script 302.

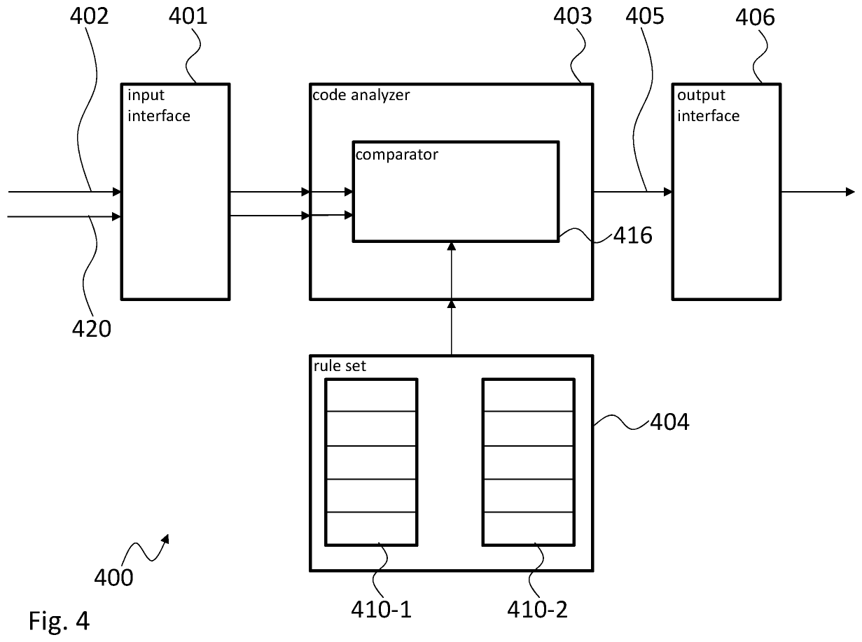

FIG. 4 shows a block diagram of a measurement application device script analyzer 400. The measurement application device script analyzer 400 is based on the measurement application device script analyzer 100. Therefore, the measurement application device script analyzer 400 comprises a script input interface 401 that is coupled to an instruction analyzer 403. The instruction analyzer 403 is coupled to an output interface 406. The explanations provided for any of the other embodiments of the measurement application device script analyzer herein apply mutatis mutandis to the measurement application device script analyzer 400.

In the measurement application device script analyzer 400, the instruction analyzer 403 comprises a comparator 416, as also shown in the measurement application device script analyzer 300. It is understood, that the comparator may also be used in any other embodiment of the measurement application device script analyzer disclosed herein.

In contrast to the comparator 316, the comparator 416 serves for directly comparing the instructions of the control script 402 with the rules of the rule set 404.

In the measurement application device script analyzer 400, the script input interface 401 receives the control script 402, and in addition also receives a measurement application description 420.

Without the measurement application description 420, rules in the rule set 404 may only provide general guidelines, or may only be provided with general limits or thresholds, because no details about the measurement application are known.

The measurement application description 420 may comprise a detailed description at least of a measurement application device that is to execute the control script 402. The measurement application description 420 may also comprise additional information about any other device that may be coupled to the respective measurement application device, like a device under test, and other measurement application devices, or devices that provide support functions in the respective measurement application.

With this knowledge, the rules of the rule set 404 may be more specifically formulated, and may take into account the specific details of the measurement application description 420.

In the measurement application device script analyzer 400, the rule set 404 comprises two groups of rules 410-1, 410-2. One of the groups of rules 410-1, 410-2 may comprise rules that apply, when no measurement application description 420 is available. The other one of the groups of rules 410-1, 410-2 may comprise rules that apply, when the measurement application description 420 is provided to the instruction analyzer 403.

In embodiments, the measurement application description 420 may not cover all elements of a measurement application or all elements that the control script 402 refers to. Therefore, in such embodiments, both groups of rules 410-1, 410-2 may be provided.

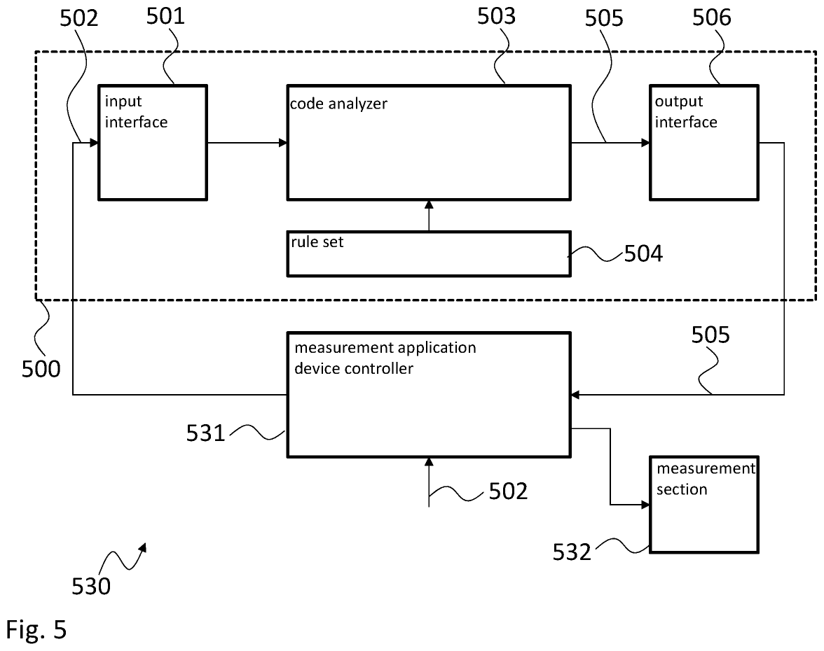

FIG. 5 shows a block diagram of a measurement application device 530.

The measurement application device 530 comprises a measurement application device script analyzer 500, and a measurement application device controller 531 that is coupled to the script input interface 501. The measurement application device controller 531 is further coupled to a measurement section 532.

The measurement application device script analyzer 500 is based on the measurement application device script analyzer 100. Therefore, the measurement application device script analyzer 500 comprises a script input interface 501 that is coupled to an instruction analyzer 503. The instruction analyzer 503 is coupled to an output interface 506. The explanations provided for any of the other embodiments of the measurement application device script analyzer herein apply mutatis mutandis to the measurement application device script analyzer 500. Further, in the measurement application device 530 any embodiment of the measurement application device script analyzer may be used, instead of the shown measurement application device script analyzer 500.

In the measurement application device 530, a user may provide the control script 502 to the measurement application device controller 531. The user may e.g., load the control script 502 from a data carrier, like a USB stick, or may load the control script 502 from a network storage or server.

The measurement application device controller 531 may then provide the control script 502 to the measurement application device script analyzer 500, and depending on the analysis result 505 provided by the measurement application device script analyzer 500, may then control the measurement section 532 based on the control script 502 or not.

In embodiments, the control script 502 may also be provided to the measurement application device 530 for direct or immediate execution in or by the measurement application device 530. In such embodiments, the measurement application device controller 531 may provide single instructions or multiple instructions of the control script 502 that are received for execution in the measurement application device 530 to the measurement application device script analyzer 500 as they are received. The measurement application device controller 531 may then only execute the respective instructions, if the analysis result 505 provided by the measurement application device script analyzer 500 indicates that the instructions may be executed.

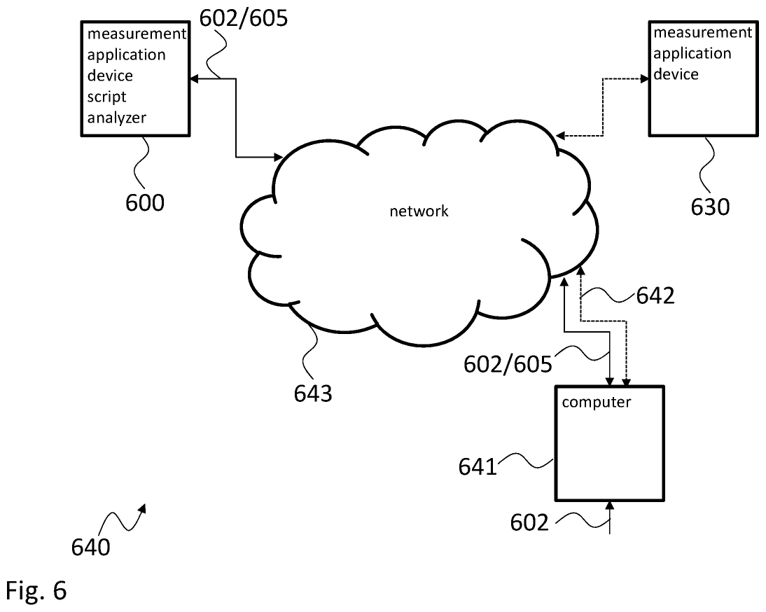

FIG. 6 shows a block diagram of a measurement application 640. The measurement application 640 is an example of a distributed measurement application, where multiple devices are coupled to each other via a network 643.

The measurement application 640 comprises a measurement application device script analyzer 600 that is coupled to the network 643. Further, a measurement application device 630, and a computer 641 are coupled to the network 643.

The network 643 may be a local network or may at least in part comprise a public network, like the internet. In the measurement application 640 at least one of the elements, especially the measurement application device script analyzer 600, may be provided as a server that is accessible from the computer 641 via the internet.

In such an embodiment, the measurement application device script analyzer 600 may provide a respective API, like a REST-API, and/or may serve a respective web site that provides the user with access to the functionality of the measurement application device script analyzer 600.

The measurement application device 630 may also provide a respective API for controlling the measurement application device 630, and/or may serve a web site that allows the user of the computer 641 to control the measurement application device 630.

In embodiments, the measurement application device script analyzer 600 may provide a web site to a browser that is executed on the computer 641 by a user that allows controlling the measurement application device 630. Such a web site may be provided e.g., by the manufacturer of the measurement application device 630, and/or the measurement application device script analyzer 600 to provide users with a central measurement application management tool.

In the measurement application 640, the computer 641 may provide a control script 602 via the network 643 to the measurement application device script analyzer 600. The control script 602 may be provided to the computer 641 by the user e.g., via a data carrier or from a network storage. The user may also use the computer 641 to write the control script 602 e.g., in a respective code editor. Such a code editor may also be provided on the web site that may be served by the measurement application device script analyzer 600.

After providing the control script 602 to the measurement application device script analyzer 600, the measurement application device script analyzer 600 will provide a respective analysis result 605 to the computer 641. If the analysis result 605 is positive, the computer 641 may provide the control script 602 to the measurement application device 630 for executing the control script 602.

In embodiments, if the analysis result 605 is positive, the control script 602 may be provided from the measurement application device script analyzer 600 directly to the measurement application device 630.

It is understood, that although only one measurement application device 630, one computer 641, and only one measurement application device script analyzer 600 are shown in the measurement application 640, any number of measurement application devices, computers, and measurement application device script analyzers is possible.

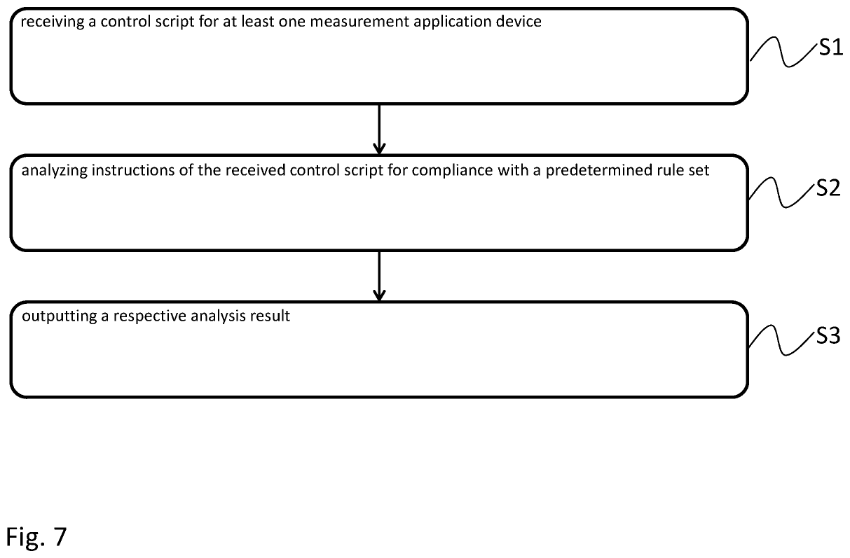

FIG. 7 shows a flow diagram of an embodiment of a computer-implemented method for analyzing control scripts for measurement applications.

The method comprises receiving S1 a control script for at least one measurement application device, analyzing S2 instructions of the received control script for compliance with a predetermined rule set, and outputting S3 a respective analysis result.

The control script may be provided in a scripting language that is interpretable by the measurement application device. The control script may e.g., be provided as at least one of a SCPI script, or a Python script.

The predetermined rule set may comprise rules that define instructions that are not allowed, instructions that may cause unwanted consequences, and instructions that comprise parameters with the potential to damage the measurement application device, or other devices coupled to the measurement application device, without being limited to these examples.

Analyzing S2 may comprise executing the control script in a sandbox environment, and monitoring the behavior of the sandbox environment.

If the analysis result is negative analyzing may comprise rejecting the control script, asking for a user confirmation to accept the control script, and modifying the script to comply with the predetermined rule set.

The method may also comprise receiving a measurement application description in addition to the control script. In this case, analyzing the received control may further be performed based on the measurement application description.

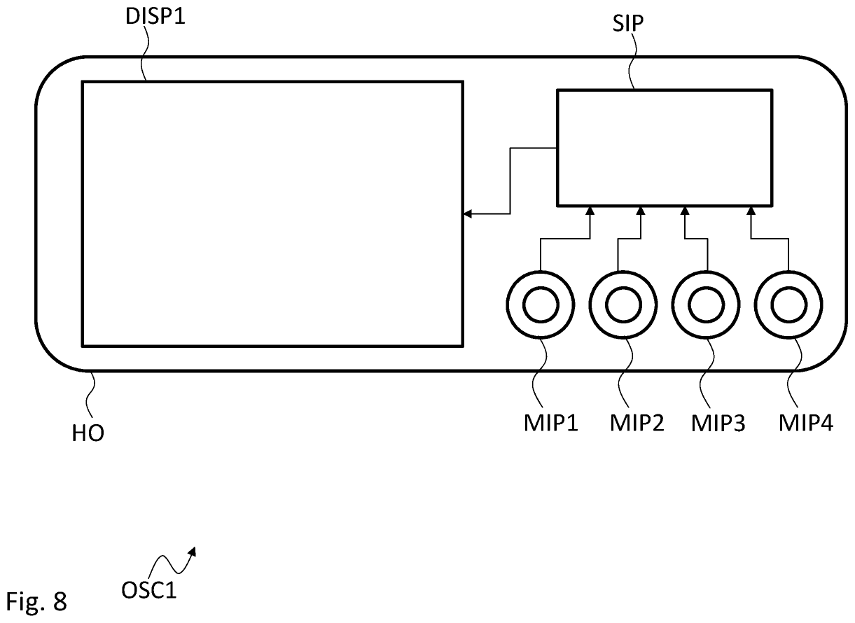

FIG. 8 shows a block diagram of an oscilloscope OSC1 that may be used with or as an embodiment of a measurement application device script analyzer according to the present disclosure.

The oscilloscope OSC1 comprises a housing HO that accommodates four measurement inputs MIP1, MIP2, MIP3, MIP4 that are coupled to a signal processor SIP for processing any measured signals. The signal processor SIP is coupled to a display DISP1 for displaying the measured signals to a user.

Although not explicitly shown, it is understood, that the oscilloscope OSC1 may also comprise signal outputs that may also be coupled to the differential measurement probe. Such signal outputs may for example serve to output calibration signals. Such calibration signals allow calibrating the measurement setup prior to performing any measurement. The process of calibrating and correcting any measurement signals based on the calibration may also be called de-embedding and may comprise applying respective algorithms on the measured signals.

In the oscilloscope OSC1 the signal processor SIP or an additional processing element may perform the function of the measurement application device script analyzer according to the present disclosure, or may implement the measurement application device script analyzer. Of course, a communication interface may be provided in the oscilloscope OSC1 for communication with other measurement application devices.

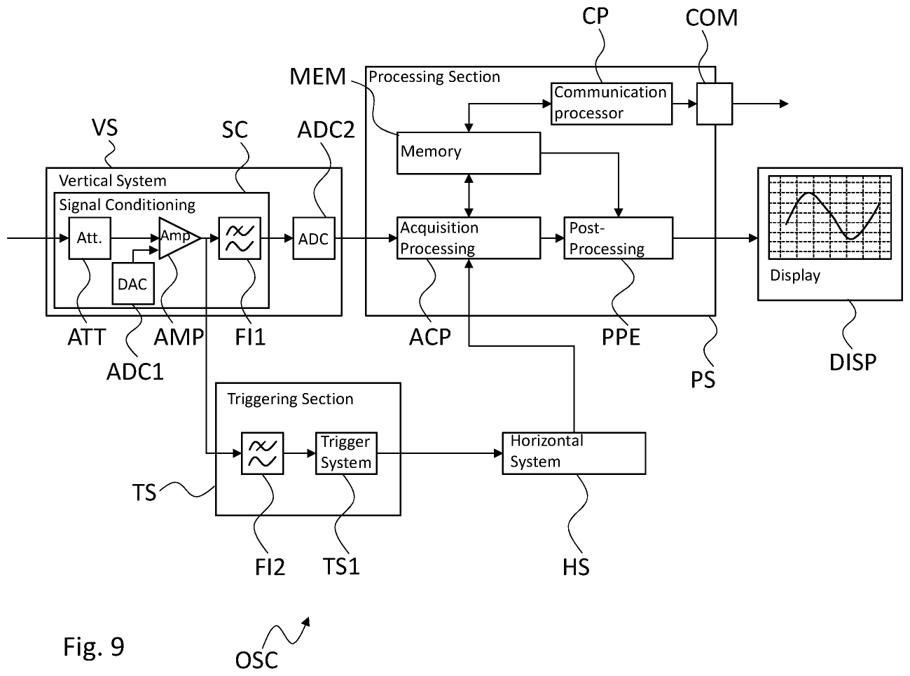

FIG. 9 shows a block diagram of an oscilloscope OSC that may be an implementation of a measurement application device according to the present disclosure or may be used with a measurement application device script analyzer according to the present disclosure. The oscilloscope OSC is implemented as a digital oscilloscope. However, the present disclosure may also be implemented with any other type of oscilloscope.

The oscilloscope OSC exemplarily comprises five general sections, the vertical system VS, the triggering section TS, the horizontal system HS, the processing section PS, and the display DISP. It is understood, that the partitioning into five general sections is a logical partitioning and does not limit the placement and implementation of any of the elements of the oscilloscope OSC in any way.

The vertical system VS mainly serves for offsetting, attenuating, and amplifying a signal to be acquired. The signal may for example be modified to fit in the available space on the display DISP or to comprise a vertical size as configured by a user.

To this end, the vertical system VS comprises a signal conditioning section SC with an attenuator ATT and a digital-to-analog-converter DAC that are coupled to an amplifier AMP1. The amplifier AMP1 is coupled to a filter FI1, which in the shown example is provided as a low pass filter. The vertical system VS also comprises an analog-to-digital converter ADC1 that receives the output from the filter FI1 and converts the received analog signal into a digital signal.

The attenuator ATT and the amplifier AMP1 serve to scale the amplitude of the signal to be acquired to match the operation range of the analog-to-digital converter ADC1. The digital-to-analog-converter DAC1 serves to modify the DC component of the input signal to be acquired to match the operation range of the analog-to-digital converter ADC1. The filter FI1 serves to filter out unwanted high frequency components of the signal to be acquired.

The triggering section TS operates on the signal as provided by the amplifier AMP. The triggering section TS comprises a filter FI2, which in this embodiment is implemented as a low pass filter. The filter FI2 is coupled to a trigger system TS1.

The triggering section TS serves to capture predefined signal events and allows the horizontal system HS to e.g., display a stable view of a repeating waveform, or to simply display waveform sections that comprise the respective signal event. It is understood, that the predefined signal event may be configured by a user via a user input of the oscilloscope OSC.

Possible predefined signal events may for example include, but are not limited to, when the signal crosses a predefined trigger threshold in a predefined direction i.e., with a rising or falling slope. Such a trigger condition is also called an edge trigger. Another trigger condition is called “glitch triggering” and triggers, when a pulse occurs in the signal to be acquired that has a width that is greater than or less than a predefined amount of time.

In order to allow an exact matching of the trigger event and the waveform that is shown on the display DISP, a common time base may be provided for the analog-to-digital converter ADC1 and the trigger system TS1.

It is understood, that although not explicitly shown, the trigger system TS1 may comprise at least one of configurable voltage comparators for setting the trigger threshold voltage, fixed voltage sources for setting the required slope, respective logic gates like e.g., a XOR gate, and FlipFlops to generate the triggering signal.

The triggering section TS is exemplarily provided as an analog trigger section. It is understood, that the oscilloscope OSC may also be provided with a digital triggering section. Such a digital triggering section will not operate on the analog signal as provided by the amplifier AMP but will operate on the digital signal as provided by the analog-to-digital converter ADC1.

A digital triggering section may comprise a processing element, like a processor, a DSP, a CPLD, an ASIC or an FPGA to implement digital algorithms that detect a valid trigger event.

The horizontal system HS is coupled to the output of the trigger system TS1 and mainly serves to position and scale the signal to be acquired horizontally on the display DISP.

The oscilloscope OSC further comprises a processing section PS that implements digital signal processing and data storage for the oscilloscope OSC. The processing section PS comprises an acquisition processing element ACP that is couple to the output of the analog-to-digital converter ADC1 and the output of the horizontal system HS as well as to a memory MEM and a post processing element PPE.

The acquisition processing element ACP manages the acquisition of digital data from the analog-to-digital converter ADC1 and the storage of the data in the memory MEM. The acquisition processing element ACP may for example comprise a processing element with a digital interface to the analog-to-digital converter ADC2 and a digital interface to the memory MEM. The processing element may for example comprise a microcontroller, a DSP, a CPLD, an ASIC or an FPGA with respective interfaces. In a microcontroller or DSP, the functionality of the acquisition processing element ACP may be implemented as computer readable instructions that are executed by a CPU. In a CPLD or FPGA the functionality of the acquisition processing element ACP may be configured in to the CPLD or FPGA opposed to software being executed by a processor.

The processing section PS further comprises a communication processor CP and a communication interface COM.

The communication processor CP may be a device that manages data transfer to and from the oscilloscope OSC. The communication interface COM for any adequate communication standard like for example, Ethernet, WIFI, Bluetooth, NFC, an infra-red communication standard, and a visible-light communication standard.

The communication processor CP is coupled to the memory MEM and may use the memory MEM to store and retrieve data.

Of course, the communication processor CP may also be coupled to any other element of the oscilloscope OSC to retrieve device data or to provide device data that is received from the management server.

The post processing element PPE may be controlled by the acquisition processing element ACP and may access the memory MEM to retrieve data that is to be displayed on the display DISP. The post processing element PPE may condition the data stored in the memory MEM such that the display DISP may show the data e.g., as waveform to a user. The post processing element PPE may also realize analysis functions like cursors, waveform measurements, histograms, or math functions.

The display DISP controls all aspects of signal representation to a user, although not explicitly shown, may comprise any component that is required to receive data to be displayed and control a display device to display the data as required.

It is understood, that even if it is not shown, the oscilloscope OSC may also comprise a user interface for a user to interact with the oscilloscope OSC. Such a user interface may comprise dedicated input elements like for example knobs and switches. At least in part the user interface may also be provided as a touch sensitive display device.

In the oscilloscope OSC, any one of the processing elements in the processing section PS or an additional processing element may perform the function measurement application device script analyzer according to the present disclosure.

It is understood, that all elements of the oscilloscope OSC that perform digital data processing may be provided as dedicated elements. As alternative, at least some of the above-described functions may be implemented in a single hardware element, like for example a microcontroller, DSP, CPLD or FPGA. Generally, the above-described logical functions may be implemented in any adequate hardware element of the oscilloscope OSC and not necessarily need to be partitioned into the different sections explained above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments.

In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

LIST OF REFERENCE SIGNS

| | |
|---|---|
| 100, 200, 300, 400, 500, 600 | measurement application |
| | device script analyzer |
| 101, 201, 301, 401, 501 | script input interface |
| 102, 202, 302, 402, 502, 602 | control script |
| 103, 203, 303, 403, 503 | instruction analyzer |
| 104, 204, 304, 404, 504 | rule set |
| 105, 205, 305, 405, 505, 605 | analysis result |
| 106, 206, 306, 406, 506 | output interface |
| 210-1, 210-2, 210-3, 410-1, 410-2 | rule group |
| 315 | sandbox environment |
| 316, 416 | comparator |
| 420 | measurement application description |
| 530, 630 | measurement application device |
| 531 | measurement application device |
| | controller |
| 532 | measurement section |
| 640 | measurement application |
| 641 | computer |
| 642 | control signal |
| 643 | network |
| OSC1 | oscilloscope |
| HO | housing |
| MIP1, MIP2, MIP3, MIP4 | measurement input |
| SIP | signal processing |
| DISP1 | display |
| OSC | oscilloscope |
| VS | vertical system |
| SC | signal conditioning |
| ATT | attenuator |
| DAC1 | analog-to-digital converter |
| AMP1 | amplifier |
| FI1 | filter |
| ADC1 | analog-to-digital converter |
| TS | triggering section |
| AMP2 | amplifier |
| FI2 | filter |
| TS1 | trigger system |
| HS | horizontal system |
| PS | processing section |
| ACP | acquisition processing element |
| MEM | memory |
| PPE | post processing element |
| DISP | display |

1. A measurement application device script analyzer comprising:
a script input interface configured to receive a control script for at least one measurement application device;
an instruction analyzer coupled to the script input interface, and configured to analyze instructions of the control script for compliance with a predetermined rule set, and to provide a respective analysis result; and
an output interface coupled to the instruction analyzer, and configured to output the analysis result.

2. The measurement application device script analyzer according to claim 1, wherein the control script is provided in a scripting language that is interpretable by the measurement application device.

3. The measurement application device script analyzer according to claim 2, wherein the control script is provided as at least one of a Standard Commands for Programmable Instruments (SCPI) script, or a Python script.

4. The measurement application device script analyzer according to claim 1, wherein the predetermined rule set comprises rules that define at least one of:
instructions that are not allowed;
instructions that may cause unwanted consequences; or
instructions that comprise parameters with the potential to damage the measurement application device, or other devices coupled to the measurement application device.

5. The measurement application device script analyzer according to claim 1, wherein the instruction analyzer comprises a sandbox environment, wherein the instruction analyzer is configured to execute the control script in the sandbox environment and monitor the behavior of the sandbox environment.

6. The measurement application device script analyzer according to claim 1, wherein the instruction analyzer is configured to, if the analysis result is negative, at least one of:
reject the control script;
ask for a user confirmation to accept the control script; or
modify the control script to comply with the predetermined rule set.

7. The measurement application device script analyzer according to claim 1, wherein the script input interface is further configured to receive a measurement application description with the control script, and
wherein the instruction analyzer is further configured to analyze the control script based on the measurement application description.

8. A measurement application device comprising:
a script analyzer; and
a measurement application device controller coupled to the script analyzer, wherein the measurement application device controller is configured to execute a control script after receiving a positive analysis result from the script analyzer, wherein the script analyzer comprises:
a script input interface configured to receive a control script for the measurement application device;
an instruction analyzer coupled to the script input interface, and configured to analyze instructions of the control script for compliance with a predetermined rule set, and to provide a respective analysis result; and
an output interface coupled to the instruction analyzer, and configured to output the analysis result.

9. The measurement application device according to claim 8, wherein the control script is provided in a scripting language that is interpretable by the measurement application device controller.

10. The measurement application device according to claim 9, wherein the control script is provided as at least one of a SCPI script, or a Python script.

11. The measurement application device according to claim 9, wherein the predetermined rule set comprises rules that define at least one of:
instructions that are not allowed;
instructions that may cause unwanted consequences; or
instructions that comprise parameters with the potential to damage the measurement application device, or other devices coupled to the measurement application device.

12. The measurement application device according to claim 8, wherein the instruction analyzer comprises a sandbox environment, wherein the instruction analyzer is configured to execute the control script in the sandbox environment and monitor the behavior of the sandbox environment.

13. The measurement application device according to claim 8, wherein the instruction analyzer is configured to, if the analysis result is negative, at least one of:
reject the control script;
ask for a user confirmation to accept the control script; or
modify the control script to comply with the predetermined rule set.

14. The measurement application device according to claim 8, wherein the script input interface is further configured to receive a measurement application description with the control script, and
wherein the instruction analyzer is further configured to analyze the control script based on the measurement application description.

15. A computer-implemented method comprising:
receiving a control script for at least one measurement application device;
analyzing instructions of the control script for compliance with a predetermined rule set; and
outputting a respective analysis result.

16. The computer-implemented method according to claim 15, wherein the control script is provided in a scripting language that is interpretable by the measurement application device.

17. The computer-implemented method according to claim 16, wherein the control script is provided as at least one of a SCPI script, or a Python script.

18. The computer-implemented method according to claim 15, wherein the predetermined rule set comprises rules that define at least one of:
instructions that are not allowed;
instructions that may cause unwanted consequences; or
instructions that comprise parameters with the potential to damage the measurement application device, or other devices coupled to the measurement application device.

19. The computer-implemented method according to claim 15, wherein analyzing comprises executing the control script in a sandbox environment, and monitoring the behavior of the sandbox environment.

20. The computer-implemented method according to claim 15, wherein analyzing comprises, if the analysis result is negative, at least one of:
rejecting the control script;
asking for a user confirmation to accept the control script; or
modifying the control script to comply with the predetermined rule set.

21. The computer-implemented method according to claim 15, wherein in addition to the control script a measurement application description is received, and
wherein analyzing the control script is further performed based on the measurement application description.
